(19) United States
(12) Patent Application Publication
(10) Pub. No.: US 2009/0028338 A1
(43) Pub. Date: Jan. 29, 2009

(54) SOFTWARE PRODUCT AUTHENTICATION

(76) Inventor: Thomas Martin, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/162,682

(22) PCT Filed: Feb. 2, 2007
(86) PCT No.: PCT/GB07/00373

§ 371 Date: Jul. 30, 2008

(30) Foreign Application Priority Data
Feb. 3, 2006 (EP) 06250592.0

(51) Int. Cl. H04L 9/06; G06F 21/00

(52) U.S. Cl. 380/277; 726/2

(57) ABSTRACT

The present application discloses a method and a system for authenticating software products. Computer software is often sold with a unique validation number. In order to register the product a user has to connect to a remote server and he is then asked to enter the validation number. The disadvantage of this is that it can take time, and further the verification can be delayed or entirely prevented due to network problems. The invention solves this problem by supplying a validator (219) with the software product so that the user can register and validate the software product off-line. In order to achieve this the validation number comprises an index and a validation code, which is the index signed with the software producer's private key. A corresponding public key (203) is distributed to the user and the user can then operate on the validation code and index using the validator (219) and the public key (203) to validate the validation code as one generated from the applied index and the private key.

This invention relates to a method of and an apparatus for authenticating software products.

It is known to provide each of a large number of similar products with a ‘serial number’ which uniquely identifies each product. This can then be used in quality control and other situations where identification of a particular product is required. In some circumstances, valid serial numbers can be a subset of numbers of the same length—for example not all 16-digit decimal numbers are valid credit card numbers—such serial numbers are referred to as validation numbers in this specification.

To guard against computer software piracy, it is common for computer software products to be sold with a unique validation number (or key). This is sometimes printed on a sticker which is stuck on the product packaging. On installation, a user will be prompted to input the validation number and installation only proceeds if the validation number is verified as being a valid validation number. Alternatively, computer software may only run with reduced functionality or may expire after a predetermined period of time unless it is unlocked by the user entering a valid validation number.

The fraction of numbers having the same length as a validation number and which are in fact valid validation numbers determines the resistance of the validation number scheme to a brute force attack (trying a large number of possibilities, e.g. exhaustively working through all possible validation numbers, in order to find a valid one). A validation number range which is many orders of magnitude greater than the number of similar products to be uniquely identified will require more work than is feasible for an attacker, even if he uses a large number of powerful, high-specification computers to perform the search. Thus, size of the validation number range in comparison to the number of products to be uniquely identified is important in resisting this type of attack. In other words, the length of the validation number in comparison to the length of a number which equals the number of products to be uniquely identified is important in resisting a brute-force attack.

However, as already mentioned, a user manually inputs the validation number on installation and therefore if the validation number is too long, it may become unmanageable and the probability of the user making a mistake when inputting the validation number increases. The user would then be faced with the inconvenience of having to re-enter the validation number.

US patent application US 2005/0262338 describes a system and method for providing an authentication code across a network for use in authentication of documents, such as printed lottery tickets. The system includes document-printing terminals that create a public/private key pair, with the private key being used to generate an authentication code for printing on the document, and the public key being sent to a central server and used to verify that the private key was used in creating the authentication code, and thereby verify that the lottery ticket is genuine. The central server can also provide ticket serial numbers for tickets being dispensed at the terminals and the private key can be combined with the serial number and other secondary data to create the authentication code.

The disadvantage with the system and method of US patent application US 2005/0262338 is that the verification step has to be done at a remote server, which can take time, and further the verification can be delayed or entirely prevented due to network problems etc.

According to a first aspect of the present invention there is provided a method for software product authentication comprising the steps of creating a set of index numbers for each of a plurality of products; signing each index number with a private key in order to generate a validation code; applying said index numbers and corresponding validation codes to respective products or product packages; and supplying a validator for validating the validation code applied to the product; the method further comprising the steps of: receiving a public key which pairs with the private key; and then operating on said validation code and said index using the validator and the public key to validate the validation code as one generated from the applied index number and the private key.

By having a software product authentication method which generates a set of index numbers for each of a plurality of products, and generates a validation code for each index by signing the index number with a private key and by verifying that a validation code is generated from the applied index and the private key, validation numbers that are both resistant to a brute-force attack and manageable by users can be verified. Moreover, the same validator and public key can be distributed to all users and there is no need to store a list of all valid validation numbers. The validation can therefore be done locally at the point of use and there is no need for a remote validation server.

Further, by generating a set of index numbers having one index number for each product, only the number of validation numbers required by a software developer are created and valid validation numbers are sufficiently rare to make the probability of randomly guessing a valid validation number (even in an automated, brute-force attack) so low as to make this approach unfeasible. The validation numbers can also be made sufficiently short so that they are manageable by users. Moreover, an attacker cannot generated a signature for a particular index without knowing the software developer's private key.

Preferably, said validation code comprises a hash of said index that has been signed with a private encryption key. In this way, the validation number can be made even more secure.

The validation code and the index number can further be concatenated or interleaved or combined in any other way to generate a validation number.

Preferably, the combination of the validation code and the index is encoded in order to generate a shorter character string that can be more easily entered by the user. The higher the base of the encoding, the shorter the character string becomes.

In some embodiments, the validation number comprises a plurality of character blocks, each character block comprising a check digit computed from the remaining characters in said character block, said method further comprising the antecedent steps of:
(i) receiving one of said plurality of character blocks;
(ii) checking the correctness of the check digit of said received block;
(iii) storing said character block if said check digit is correct; and
(iv) iteratively repeating steps (i) to (iii) until all character blocks of said validation number have been stored.

In this way, the inputting of validation number by a user can be made more interactive. By adding a check digit to each character block it is possible to detect when a small error has occurred when a user inputs that block. Preferably, feedback can be provided to the user after the input of the block so that the user can be assured they have entered the block correctly or prompted to retry if there is an error.

According to a second aspect of the present invention there is provided a system for authenticating a software product comprising
an index number generator (207) for generating a set of index numbers for respective products;
validation code generation means (209) arranged in operation to generate valid validation codes by digitally signing each index number with a private key (205); and
a validator (219) for validating the validation code, said validator being supplied with the product, and arranged in operation to receive a public key corresponding to said private key and operating on said validation code and said index number using the public key to validate the validation code as one generated from the applied index number and the private key.

One advantage with the system is that a user does not need to connect to a remote server in order to authenticate a product but the authentication can be done locally, at the point of use of the product. This means that the validation can be faster. Further, an attacker cannot generate a signature for a particular index without knowing the developer's private key which also increases the security of the system.

According to a third aspect of the present invention there is provided a computer program, which, when executed on data processing apparatus, causes said data processing apparatus to perform a method according to the first aspect of the present invention.

According to a fourth aspect of the present invention there is provided a computer readable medium storing a computer program according to the third aspect of the present invention.

According to a fifth aspect of the present invention there is provided apparatus for verifying that a validation number is a valid validation number, wherein valid validation numbers comprise an encoded concatenation of an index and a signature, said index forming part of a larger set of bit strings that includes one valid validation number for each index, said signature comprising said index signed with a private encryption key, said apparatus comprising:
validation number reception means arranged in operation to receive a validation number to be verified;
validation number validation means arranged in operation to extract said index and said signature and verify that said validation number is a valid validation number if said signature is a valid signature of said index.

According to a sixth aspect of the present invention there is provided apparatus for generating a valid validation number from a set of bit strings, a subset of said set of bit strings being indexed by a smaller set of indices wherein each index is used to form one valid validation number, said apparatus comprising:
validation number generation means arranged in operation to generate a validation number by digitally signing said index with a private encryption key to form a signature.

Other aspects of the present invention are defined in the claims.

Embodiments of the present invention will now be described, by way of example only, with reference to the accompanying drawings, wherein like reference numbers refer to like parts, and in which:

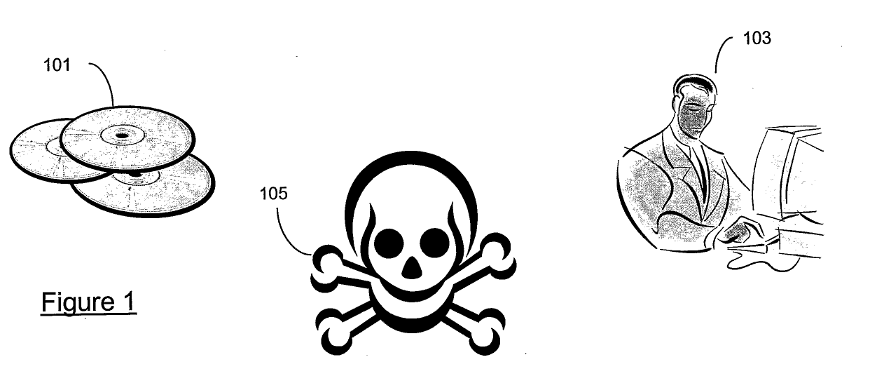

FIG. 1 is a block diagram showing the different parties to the processes of generating and validating validation numbers according to the present invention;

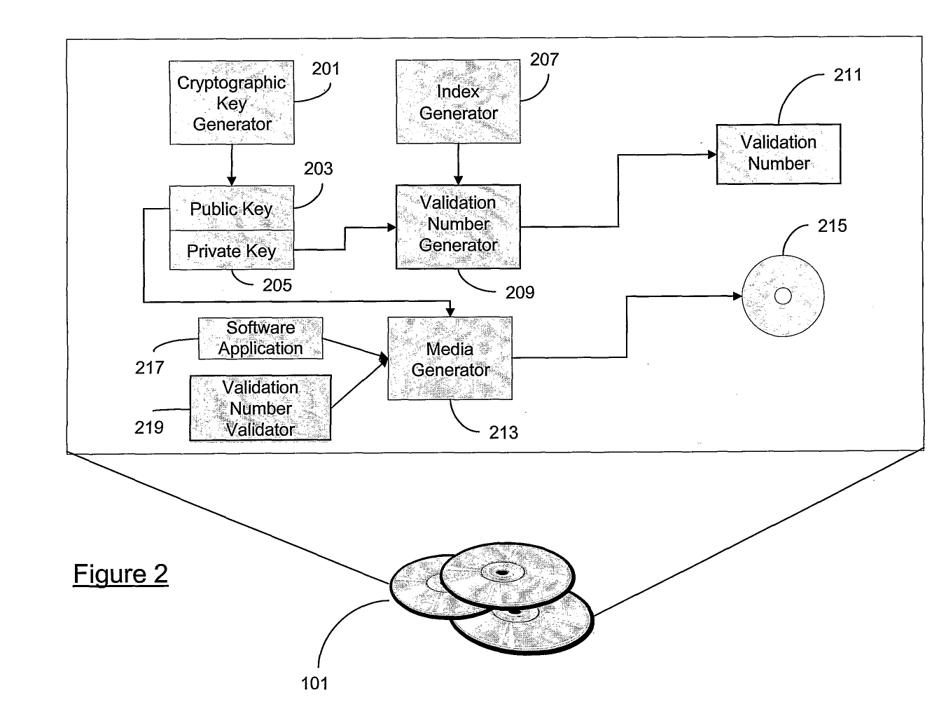

FIG. 2 is a block diagram showing the apparatus that can be used by a software developer to generate validation numbers;

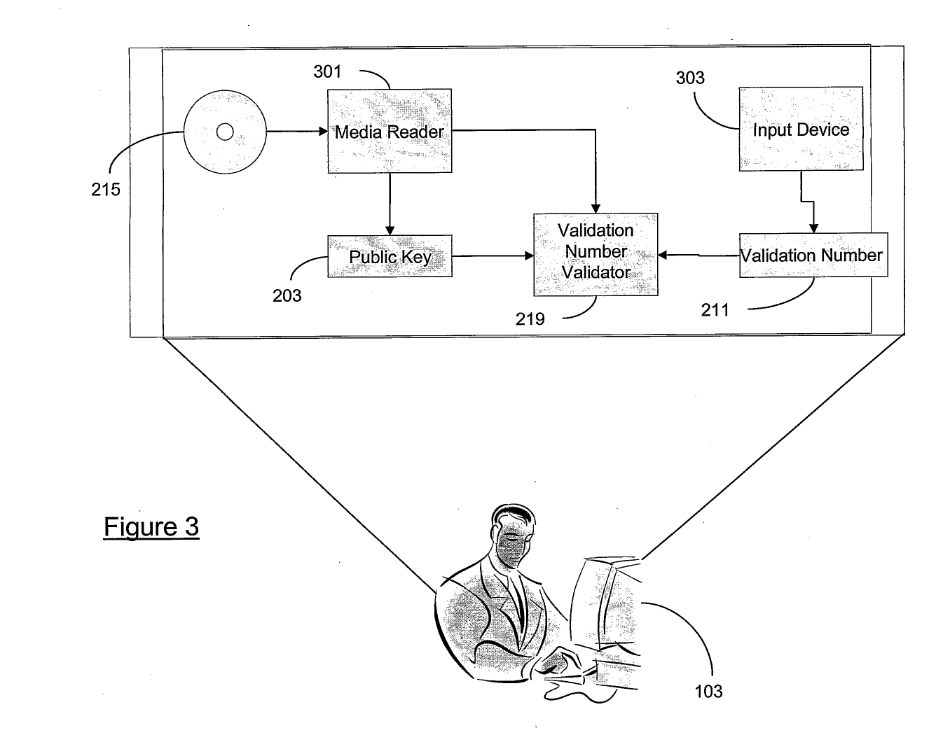

FIG. 3 is a block diagram showing apparatus that can be used by an end user 103 to validate a validation number;

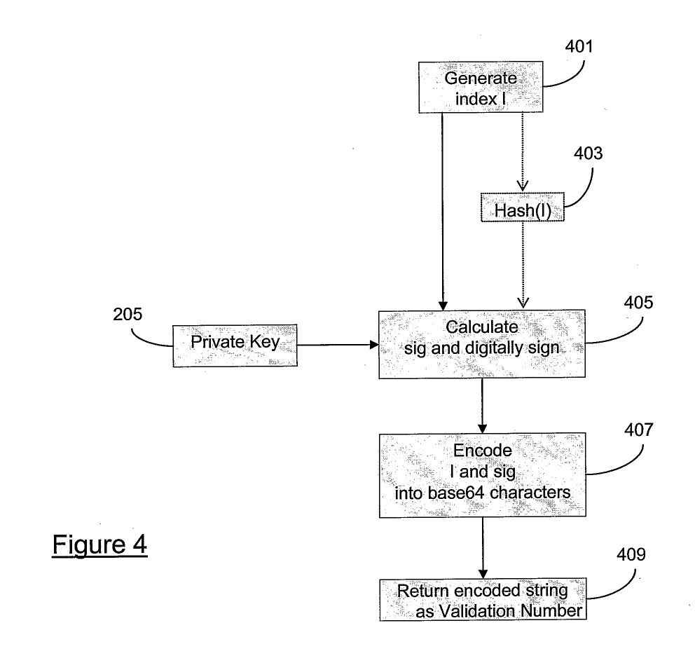

FIG. 4 is a flow chart showing the process of generating validation numbers according to a first embodiment of the present invention;

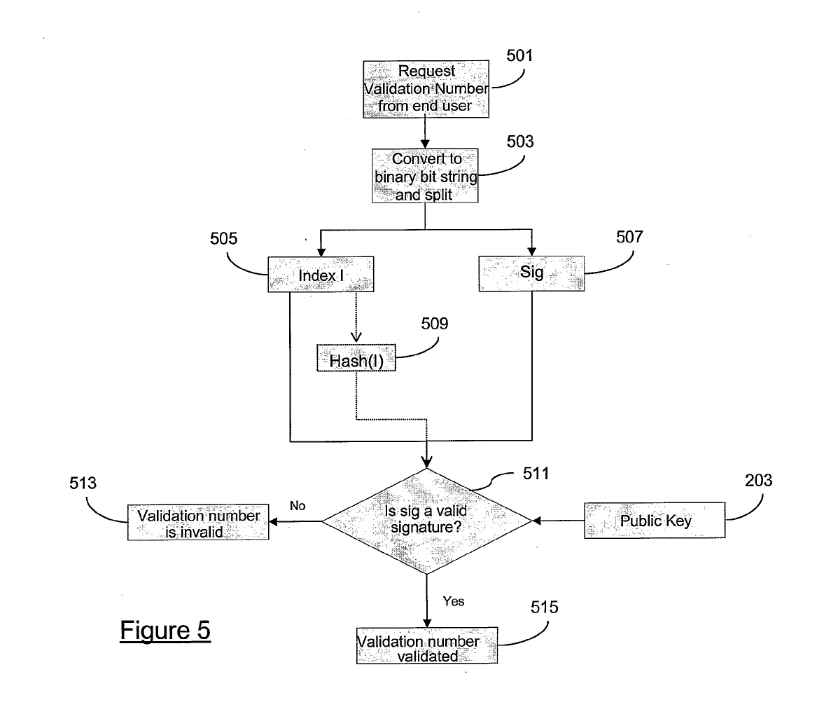

FIG. 5 is a flow chart showing the process of validating validation numbers according to a first embodiment of the present invention;

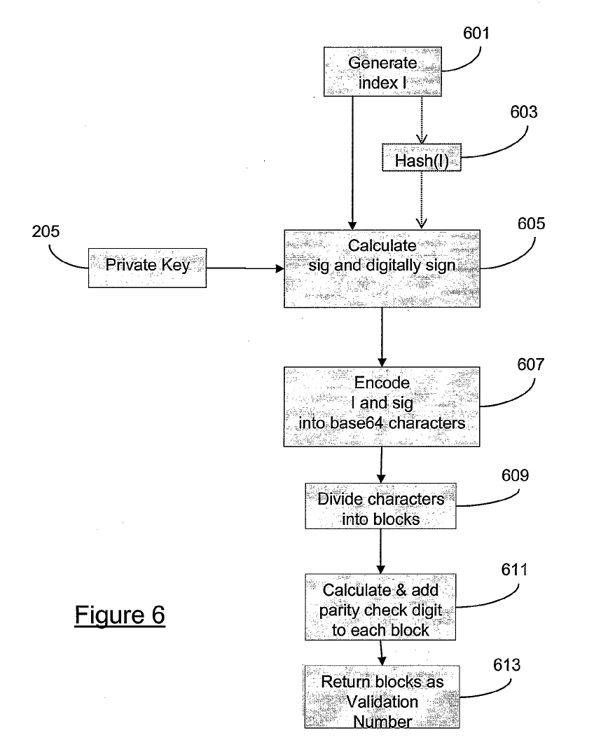

FIG. 6 is a flow chart showing the process of generating validation numbers according to a second embodiment of the present invention;

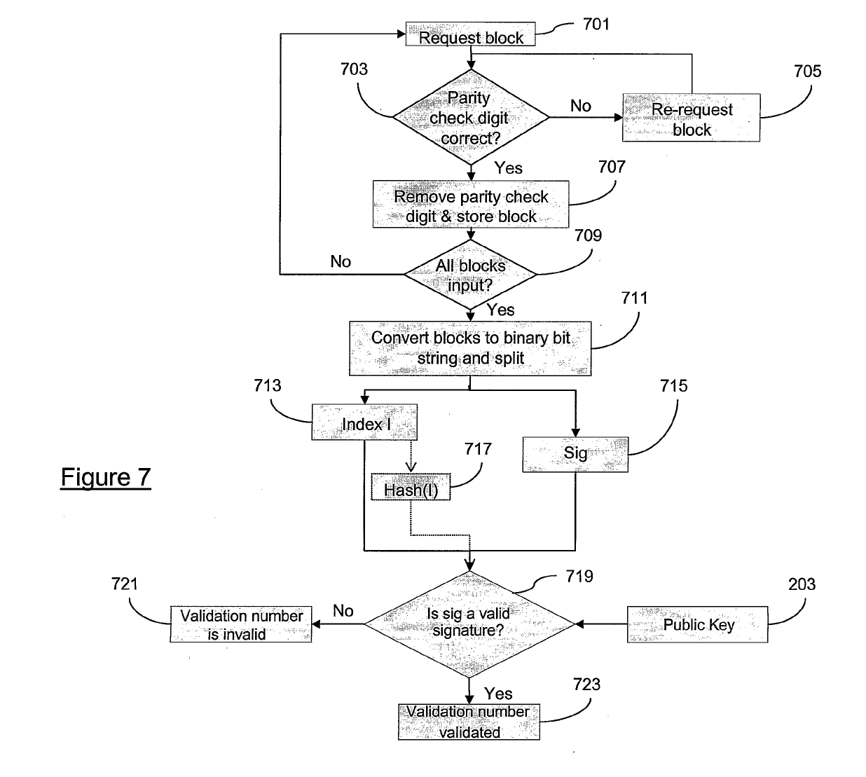

FIG. 7 is a flow chart showing the process of validating validation numbers according to a second embodiment of the present invention.

Referring to FIG. 1, embodiments of the present invention will now be described in relation to three parties: a software developer 101 who develops a new software application and distributes it with a validation number in order to prevent unauthorised access; an authorised end user 103 who purchases a copy of the new software and a valid validation number; and an unauthorised ‘attacker’ 105 who wishes to obtain and redistribute a working copy of the new software without paying for it.

In embodiments of the present invention, validation numbers consists of two parts that are concatenated on generation by a software developer. The first part is an index and there is one index for each valid validation number. The second part of the validation number is a signature obtained by signing a hash of the index using a private encryption key known only to the software developer.

FIG. 2 shows apparatus according to embodiments of the invention that can be used by a software developer 101 to generate validation numbers and to include those validation numbers with a new software application that is to be distributed to an end user 103. The apparatus includes a cryptographic key generator 201 for generating a public encryption key 203 and a private encryption key 205. In the present embodiment, such encryption keys 203/205 are generated according to the McEliece public key cryptosystem as described in “A public-key cryptosystem based on algebraic coding theory” McEliece R. J., JPL DSN Progress Report 4244 (1978), 114-116.

The software developer apparatus also comprises an index generator 207 for generating a unique index number for every valid validation number that is required. Thus, if for example the software developer 101 expects to distribute forty million copies of the software, forty million index numbers are required.

The software developer apparatus further comprises a validation number generator 209 for generating a validation number 211 from the generated index numbers and software developers' private encryption key 205. The process of how validation numbers are generated will be described in more detail later.

The software developer apparatus also includes media generator 213 for generating medium 215 suitable for distributing to end user 103. In the present embodiment, medium 215 comprises a compact disc on which is stored a new software application 217 to be distributed to end user 103 and also public encryption key 203. The generated validation number 211 is distributed with medium 215. In the present embodiment, validation number 211 is printed on the packaging that the compact disc is distributed in. Also stored on medium 215 is validation number validator 219 that is to be used by end user 103 in order to validate the validation number 211 that is distributed with medium 215. The process of how validation numbers are validated will be described in more detail later.

FIG. 3 shows apparatus according to embodiments of the present invention that can be used by an end user 103 to validate a validation number 211 that the end user 103 has purchased together with a new software application. It will be remembered that the software developer 101 distributes a medium 215 (e.g. a compact disc) containing the new software application 217, a public encryption key 203 and validation number validator 219. The end user 103 would load and install the software application 217 onto hardware suitable for running the software application 217 (e.g. by inserting medium 215 into a media reader 301 that forms part of a home personal computer (PC)). As part of the software installation process, the end user 103 would be prompted to enter the validation number 211 that was purchased by the end user 103 and distributed with medium 215. Input device 303 (e.g. a keyboard attached to the home PC) is provided to allow the end user 103 to enter the validation number 211. The validation number validator 219 uses validation number 211 (as input by the end user 103) and public key 203 (as provided by the software developer 101 on medium 215) in order to validate the validation number. The process of how validation numbers are validated will be described in more detail later.

The process of how validation numbers are generated will now be described with reference to FIG. 4.

In a step 401, software developer 101 generates an index number I. In the present embodiment, the index numbers comprise binary bit strings whose length is dependent on the number of index numbers required and hence the number of copies of the software application the software developer 101 expects to distribute. In the following embodiments of the present invention, it is assumed that software developer 101 expects to sell a maximum of forty million units of new software application 217. Consequently, forty million index numbers are required, 2^{x}=40,000,000 where x is the length (in bits) of the index number and therefore, index number I comprises a 26-bit binary string.

In step 405, Index I is digitally signed using the software developer's private key 205 to form digital signature, sig. The digital signature scheme used in the embodiments of the present invention is that described in “How to achieve a McEliece-based Digital Signature Scheme” Courtois, N., Finiasz, M. & Sendrier, N., Advances in Cryptology—ASIACRYPT 2001: 7^{th} International Conference on the Theory and Application of Cryptology and Information Security, p157, 2001. Preferably, the short signature scheme as described in the above referenced document is used to create a signature that is eighty one bits in length. Other appropriate digital signature schemes will be apparent to those skilled in the art. For example, “Short Signatures from the Weil Pairing” Boneh, D., Lynn, B. & Shacham, H., Proceedings of Asiacrypt 2001, Volume 2248 of LNCS, pages 514-532” describes a digital signature scheme that produces signatures of one hundred and seventy one bits.

In preferred embodiments, an optional step 403 can be included between steps 401 and 405. In step 403, a hash function (e.g. US Secure Hash Algorithm 1 (SHA-1) as described in Request for Comment (RFC) 3174 of the Internet Engineering Task Force (IETF)) is used to compute the hash of the index number, Hash(I) and then Hash(I) is digitally signed in step 405 using private key 205. Other suitable hash functions will be apparent to those skilled in the art.

In step 407, the index I and signature sig are concatenated and then encoded using base64 (a binary to text encoding scheme described in RFC 1421 and RFC 2045 of the IETF) to form validation number 211. In the present embodiment, the concatenation of index I and signature sig produces a one hundred and seven bit string, which when encoded using a base64 produces an eighteen-character validation number.

The process of how validation numbers are validated will now be described with reference to FIG. 5.

In a first step 501, a validation number is requested from end user 103. Once end user 103 has entered the validation number, in step 503 it is split into its two constituent parts: index I 505 and digital signature sig 507. Then a test is carried out (step 511) to check whether signature sig 507 is a valid signature for Index I 505. If the result of the test is negative, the validation number is deemed to be invalid (step 513) and end user 103 is informed. If the result of the test is positive, the validation number is validated (step 515) and end user 103 is informed.

In the present embodiment, the test (step 511) comprises using public encryption key 203 of software developer 101 to decrypt signature sig 507, the result of the decryption being another version of Index I. This version of Index I is then compared with Index I 505 and if there is a match (i.e. if sig is a valid signature for Index I) then in step 515 the validation number is validated. If there is no match, the validation number is deemed to be invalid (step 513).

In preferred embodiments where sig 507 comprises a digitally signed version of Hash(I) step 509 is additionally performed. In step 509, the same hash function as used by the software developer 101 in step 403 (as described above) is used to compute the hash of index I 505 Hash(I) 509. Then in step 511, the test checks whether signature sig 507 is a valid signature for Hash(I). In such embodiments, the test comprises using public encryption key 203 of software developer 101 to decrypt signature sig 507, the result of the decryption being another version of Hash(I). This version of Hash(I) is then compared with Hash(I) 509 and if there is a match (i.e. if sig is a valid signature for Hash(I)) then in step 515 the validation number is validated. If there is no match, the validation number is deemed to be invalid (step 513).

What now follows is an illustration of how the present invention is able to provide validation numbers that are resistant to a brute force attack. In the illustration, it is assumed that a software developer 101 expects to sell a maximum of forty million units of a new software application 217.

The following variables will be used in the description that follows:

v the number of valid validation numbers required by the software developer 101 (i.e. the maximum number of units the software developer 101 expects to sell);
s the number of different signatures;
t₁ the length of time it takes to make one verification on a computer that only has the minimum specifications required by the software (i.e. a computer that is to be used by end user 103);
t₂ the length of time it takes to make one verification on a maximum specification computer that an attacker 105 is likely to use;
x the number of computers an attacker 105 will devote to look for a valid validation number;
l an upper bound on the length of time an attacker 105 will spend looking for a valid validation number before giving up;
p the probability of an attacker 105 finding a valid validation number.

The number of attempts by an attacker 105 to find a valid validation number in 1 second=1/t₂

The number of attempts by an attacker 105 to find a valid validation number in l seconds=l/t₂

Therefore, the number of attempts to find a valid validation number that are possible using x maximum specification computers in time l=m=xl/t₂

The probability that any one random attempt to guess a validation number is valid=v/s

The probability that any one random attempt to guess a validation number is invalid=1−v/s

The probability that m random attempts to guess validation numbers are all invalid=(1−v/s)^{m}

The probability that at least one attempt out of m random attempts to guess validation numbers codes is valid=1−(1−v/s)^{m}

The software developer 101 requires 1−(1−v/s)^{m}<p

v/s is extremely small and m is required to be large. Therefore, using binomial expansion:

1−(1−v/s)^{m}−mv/s

Now m=x*l/t₂. Therefore, (x*l*v)/(s*t₂)<p

If the software developer 101 were to fix t₂, then s>(x*l*v)/(p*t₂)

If the software developer 101 were to fix s, then t₂>(x*l*v)/(p*s)

As already mentioned, in embodiments of the present invention, it is assumed that a software developer 101 expects to sell a maximum of forty million units (i.e. v=40,000,000), that an attacker 105 will devote one hundred maximum specification computers to finding valid validation numbers (i.e. x=100) and that the attacker 105 will spend a maximum of one year trying (i.e. l=31536000 seconds). The software developer 101 wants the attacker 105 to have no more than a one percent chance of success (i.e. p=0.01).

In a first scenario, if the software developer 101 decided that verification should not take longer than t₁=1s on a minimum specification computer and assuming the difference between a minimum and maximum specification computer was a factor of one thousand (i.e. t₂=0.001), then s>1.26*10²²=2⁷⁴. In this case, the signature would need to be a binary number having at least seventy-four bits if the probability of an attacker 105 finding a valid validation number under the conditions set out above is to be less than 1%. In other words, as long as the signature part of the validation number comprised at least seventy-four bits, the validation number is resistant to a brute force attack. It should be noted that this does not overrule any length requirements of the specific signature scheme used. The length of the signature is chosen to satisfy both the above minimum length and any specific security requirements for the chosen signature scheme.

Since v=40,000,000, the number of bits in the binary number index is at least log₂(40,000,000)≈26 bits. With an index of twenty-six bits and a signature of seventy-four bits, the validation number therefore comprises one hundred bits. Using base64 results in an seventeen-character validation number, which is easily read and entered by end user 103.

In an alternative scenario, if the software developer 101 decided to use a signature scheme where the signature comprised 81 bits (as in the above mentioned McEliece signature scheme), then t₂>0.000005217s if the probability of an attacker 105 finding a valid validation number under the conditions set out above is to be less than 1%. In other words, as long as it takes an attacker longer than 0.000005217s to make one verification on a maximum specification computer that he is likely to use, the validation number is resistant to a brute force attack. Digital signature verification algorithms that are currently available take at least a millisecond (0.001s) to make one verification.

With an index of twenty-six bits and a signature of eighty one bits, the validation number therefore comprises one hundred and seven bits. Using base64 results in an eighteen-character validation number, which is easily read and entered by end user 103.

The table below shows different options for the number of units a software developer 101 expects to distribute (ranging from forty million to one billion), the number of indices that would be required; and the length of the resultant validation number in dependence on two different signature schemes (one producing eighty one bit signatures and the other producing one hundred and seventy one bit signatures).

| Units of | Index | Signature | Validation number |
|---|---|---|---|
| software | Length | Length | Length |
| 40000000 | 26 | 81 | 18 |
| 50000000 | 26 | 81 | 18 |
| 100000000 | 27 | 81 | 18 |
| 500000000 | 29 | 81 | 19 |
| 1000000000 | 30 | 81 | 19 |
| 40000000 | 26 | 171 | 33 |
| 50000000 | 26 | 171 | 33 |
| 100000000 | 27 | 171 | 33 |
| 500000000 | 29 | 171 | 34 |
| 1000000000 | 30 | 171 | 34 |

It can be seen that even if a software developer 101 expects to distribute new software application 217 to one billion end users using a digital signature scheme that produces signatures of one hundred and seventy one bits, the length of the validation number would only have to be thirty four (base64) characters to ensure it was resistant to a brute force attack by an attacker 105.

In an alternative embodiment to the one described above, the process of validation number validation is made more interactive so that the end user is provided with feedback whilst the validation number is being entered. The feedback indicates to the end user whether they have input part of a validation number correctly and if not allows them to re-enter the part that contains an error without having to type in the whole validation number each time.

Referring now to FIG. 6, the process of generating validation numbers in the alternative embodiment will now be described. The initial steps 601, 605, 607 and optional step 603 are equivalent to steps 401, 405, 407 and optional step 403 as described above in relation to FIG. 4. The resultant base64 characters are then divided into n blocks of m characters each (step 609). In the embodiment described above, the result of the base64 encoding was an eighteen character string and hence suitable values for n and m would be three and six resulting in the eighteen base64 characters being divided into three blocks of six characters each. Then the characters in each block are used to calculate a parity check digit. Assuming a validation number has been divided into blocks of six characters (c1,c2,c3,c4,c5,c6), as in the above described embodiment, one suitable method for calculating the check digit is check digit CD=[(1*c1+2*c2+5*c3+11*c4+13*c5+17*c6) mod 63]. Mod 63 is more suitable than mod 64 because there are few numbers less than 63 that have common factors. The numbers multiplying the characters in the character block are chosen so that none of them have common factors either with each other or with 63. For longer block sizes the following multipliers could be used (1, 2, 5, 11, 13, 17, 19, 23, 29, etc.) Other ways of calculating a suitable parity check digit will be apparent to someone skilled in the art.

The parity check digit is then appended to each respective block (step 611) such that the block length is increased by one character. In the embodiment described above, this would result in three blocks of seven characters each. The three blocks are then output for software developer 101 to use as a validation number (step 613).

Referring now to FIG. 7, the process of validating validation numbers in the alternative embodiment will now be described. In a first step, the first block of the validation number is requested from end user 103 (step 701). Once the user has input the first block of the validation number, a test is performed to check that the parity check digit is correct (step 703). This can be achieved by calculating the check digit on the characters in the character block again and comparing it to the check digit that is input by the end user. If the test produces a negative result (i.e. the parity check digit is incorrect indicating that end user 103 has made an error when inputting the requested block), then the block is re-requested from end user 103 (step 705). If the test produces a positive result (i.e. the parity check digit is correct indicating that the block has been input accurately by end user 103), then the parity check digit is removed from the block and the block is stored (step 707). A test is then performed to check that all blocks of the validation number have been input by the user (step 709). If the test produces a negative result (i.e. not all blocks have been input) then the process returns to step 701 with another block being requested from end user 103. If the test produces a positive result (i.e. all blocks have been input) then, in step 711, the blocks are converted into a binary bit string and then split into index I 713 and digital signature sig 715. Step 719, 721, 723 and optional step 717 are then equivalent to steps 511, 513, 515 and optional step 509 as described above in relation to FIG. 5.

In the above described embodiments private encryption was used for signing the index number (or the hash of the index number) and public decryption of the index (or hash of the index) was used to validate the validation number. In alternative embodiments, the signature could be validated (step 511/719) using a public function that takes Hash(I) 509/717, sig 507/715 and public key 203 as its arguments. For example, consider the Digital Signature Algorithm (DSA).

It will be apparent from the foregoing description that many modifications or variations may be made to the above described embodiments without departing from the invention. Such modifications and variations include for example separation of index from the signature on the packing. The index and signature or validation number can further be printed on the product, printed on stickers stuck on packaging or sent to a user separately for instance by mail.

The validator can be distributed as additional software on a separate medium to the user and does not need to be included on the same medium as the software application. The validator can also be sent by mail to the user and the same validator can be arranged to validate further software applications.

In summary, the present application discloses a method and a system for authenticating software products.

Computer software is often sold with a unique validation number. In order to register the product a user has to connect to a remote server and he is then asked to enter the validation number. The disadvantage of this is that it can take time, and further the verification can be delayed or entirely prevented due to network problems.

The invention solves this problem by supplying a validator (219) with the software product so that the user can register and validate the software product off-line.

In order to achieve this the validation number comprises an index and a validation code, which is the index signed with the software producer's private key. A corresponding public key (203) is distributed to the user and the user can then operate on the validation code and the index using the validator (219) and the public key (203) to validate the validation code as one generated from the applied index and the private key.

1. Software product authentication method comprising the steps of:
creating a set of indices for each of a plurality of software products; signing each index with a private key in order to generate a validation code;
applying said indices and corresponding validation codes to respective software products or its product packages; and supplying, with the product, a validator for validating the validation code applied to the software product; the method further comprising the steps of:
receiving a public key which pairs with the private key; and then operating on said validation code and said index using the validator and the public key to validate the validation code as one generated from the applied index and the private key.

2. A method according to claim 1 in which the validator comprises additional software executable on computer on which the software product runs.

3. A method according to claim 1 in which the validator is recorded on the same medium as the software product.

4. A method according to claim 1, wherein said validation code comprises a hash of said index that has been signed with a private key.

5. The method according to claim 1 in which the validation code and the index are combined to generate a validation number.

6. A method according to claim 5 in which the combination of the validation code and the index is encoded.

7. A computer program, which, when executed on data processing apparatus, causes said data processing apparatus to perform a method according to claim 1.

8. A computer readable medium storing a computer program according to claim 7.

9. A system for authenticating a software product comprising an index generator for generating a set of indices for respective software products; validation code generation means arranged in operation to generate valid validation codes by digitally signing each index with a private key; and a validator for validating the validation code, said validator being supplied with the software product, and arranged in operation to receive a public key corresponding to said private key and operating on said validation code and said index using the public key to validate the validation code as one generated from the applied index and the private key.

10. A system according to claim 9 further comprising a key generator for generating private key and a public key; the private key being used for signing each of the indices to generate corresponding validation codes; and the public key being used for validating the validation codes.

11. A system according to claim 9 further comprising means for applying said indices and corresponding validation codes to respective software products or product packages.
